(19) United States
(12) Patent Application Publication
(10) Pub. No.: US 2018/0029204 A1
(43) Pub. Date: Feb. 1, 2018

(54) IMPACT DRIVE ADAPTOR SYSTEM AND METHOD

(71) Applicant: Levent Koyuncu, Port Coquitlam (CA)

(72) Inventor: Levent Koyuncu, Port Coquitlam (CA)

(21) Appl. No.: 15/224,225

(22) Filed: Jul. 29, 2016

(51) Int. Cl. B25B 13/50; B25B 21/02; B25B 13/06

(52) U.S. Cl. CPC B25B 13/50; B25B 13/065; B25B 21/02; B66D 3/16

(57) ABSTRACT

An adaptor for a power tool having a hardened cylindrical body having a tool receiving end and a lifting device engaging end. The tool receiving end which has, a square hole axially extending within the cylindrical body, for connecting between an output head of an impact rotary tool, and a lifting device receiving end. The device is used to improve speed in lifting procedures with various lifting devices.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of adaptors and more specifically relates to an impact drive adaptor system.

### 2. Description of Related Art

Many people use hoists to lift many different kind of loads. The basic hoist has two important characteristics to define it: lifting medium and power type. The lifting medium may be either wire rope, wrapped around a drum, or load-chain, raised by a pulley with a special profile to engage the chain. A hoist can be built as one integral-package unit, designed for cost-effective purchasing and moderate use, or it can be built as a built-up custom unit, designed for durability and performance. The built-up hoist is typically more expensive. Built-up units are designed for heavy to severe service, but over the years that market has decreased in size since the advent of the more durable packaged hoist. More common small portable hoists are of two main types, the chain hoist or chain block and the wire rope or cable type. Chain hoists may have a lever to actuate the hoist or have a loop of operating chain that one pulls through the block (known traditionally as a chain fall) which then activates the block to take up the main lifting chain. The block and tackle version is used on basically the same principle except input force is done by turning the wheel instead of lever, using the present invention the operator can be away from the hoist. This method of load lifting is done manually and is very labor intensive and time consuming. A suitable solution is desired.

Several attempts have been made to solve the above-mentioned problems such as those found in U.S. Pat. Nos. 5,364,073, 5,641,151, 4,948,098, 4,251,060, 4,938,454, 5,647,576, 5,238,226, 4,576,363, 2,681,204, and 2,507,889. This art is representative of lifting device manipulation means. However, none of the above inventions and patents, taken either singly or in combination, is seen to describe the invention as claimed.

### BRIEF SUMMARY OF THE INVENTION

In view of the foregoing disadvantages inherent in the known adaptors art, the present invention provides a novel impact drive adaptor system. The general purpose of the present invention, which will be described subsequently in greater detail is to provide a tool for actuating a lifting devise with an impact gun to save time and effort.

An impact drive adaptor system is disclosed herein, in a preferred embodiment, comprising an impact adaptor including a hardened steel cylindrical body having an outer wall surface, an inner wall surface, a hoist engaging end, and a drive end having, a tool receiver aperture. The impact drive adaptor is for use with a chain hoist system comprising the impact adaptor (for use); wherein the impact adaptor preferably comprises the hardened steel cylindrical body. The hardened steel cylindrical body is defined by the outer wall surface, the inner wall surface, the hoist engaging end, and the drive end; the drive end providing the tool receiver aperture for receiving a lug of an impact gun. When the impact adaptor is engaged with the lug of the impact gun and the impact gun is actuated the impact adaptor is caused to be turned such that a free chain knob is able to be manipulated to move a chain in an upward motion and alternately a downward motion via the hoist engaging end.

An impact drive adaptor for use with a screw jack system is also disclosed herein comprising: an impact adaptor including a hardened steel cylindrical body having an outer wall surface, an inner wall surface, a hoist engaging end, and a drive end having, and a tool receiver aperture. Wherein the impact drive adaptor for use with a screw jack system comprises a hardened steel cylindrical body; the hardened steel cylindrical body is defined by the outer wall surface, the inner wall surface, the hoist engaging end, and the drive end. The drive end provides the tool receiver aperture for receiving a lug of an impact gun, and when the impact adaptor is engaged with the lug of the impact gun and the impact gun is actuated the impact adaptor is caused to be turned such that the jack screw is able to be manipulated to move a jack in an upward motion and alternately a downward motion via the hoist engaging end. Other embodiments may include those for use with a hydraulic pump or the like.

According to another embodiment, a method for using impact drive adaptor system is also disclosed herein. The method of using an impact drive adaptor comprising the steps of: engaging a mechanical lifting device with an impact adaptor, and activating the impact adaptor via an impact gun causing the mechanical lifting device to raise and alternately lower. The method may be used with a mechanical chain hoist, a screw jack, hydraulic pump or the like.

The present invention holds significant improvements and serves as an impact drive adaptor system. Preferably, adaptors should provide a tool for actuating a lifting devise with an impact gun and, yet would operate reliably and be manufactured at a modest expense. Thus, a need exists for a reliable impact drive adaptor system to avoid the above-mentioned problems. The present invention is designed to work with a manual chain block, hand chain hoist, and wire rope winch.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, impact drive adaptor system, constructed and operative according to the teachings of the present disclosure.

FIG. 1 shows a perspective view illustrating an impact drive adaptor system during an ‘in-use’ condition according to an embodiment of the disclosure.

FIG. 2 is a perspective view illustrating the impact drive adaptor system comprising a cable winch adaptor assembly according to an embodiment of the present invention of the disclosure.

FIG. 3 is a perspective view illustrating the cable winch adaptor assembly being used with a metal rope hoist according to an embodiment of the present disclosure.

FIG. 4 is a perspective view illustrating use with a hydraulic pump according to an embodiment of the present disclosure.

FIG. 5 is a perspective view illustrating use with a scissor jack according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to adaptors and more particularly to a impact drive adaptor system as used to improve the speed and efficiency of a lifting system.

Generally speaking, using a mechanical hoist or jack is typically a slow and time consuming process. This is not desirable. By using an adapter fitted to a mechanical lifting system that is also fitted to an impact gun it not only makes the job easier but it will also save time and eliminate the strenuous effort of cranking on a lever or pumping a jack handle which is desirable.

A chain hoist adaptor for an impact driver is provided for allowing faster raising and lowering of a load. The device disclosed herein is handy for use on various lifting and lowering devices.

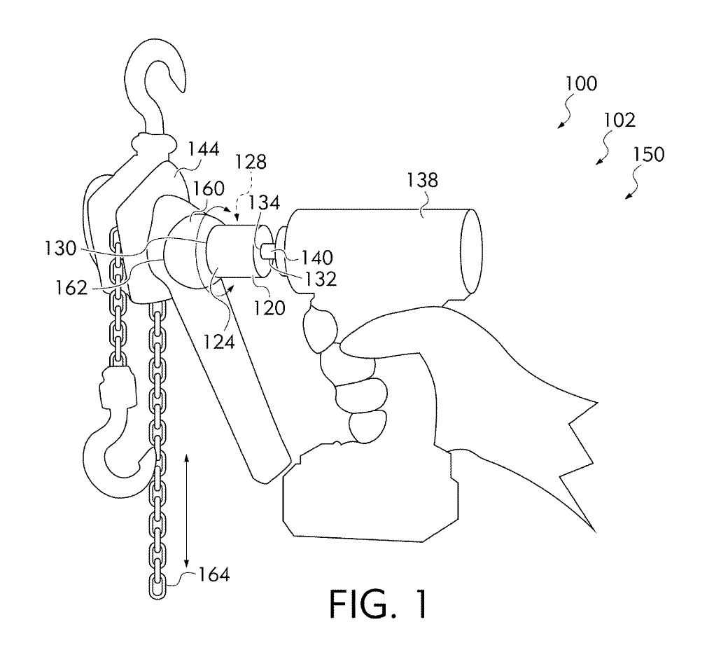

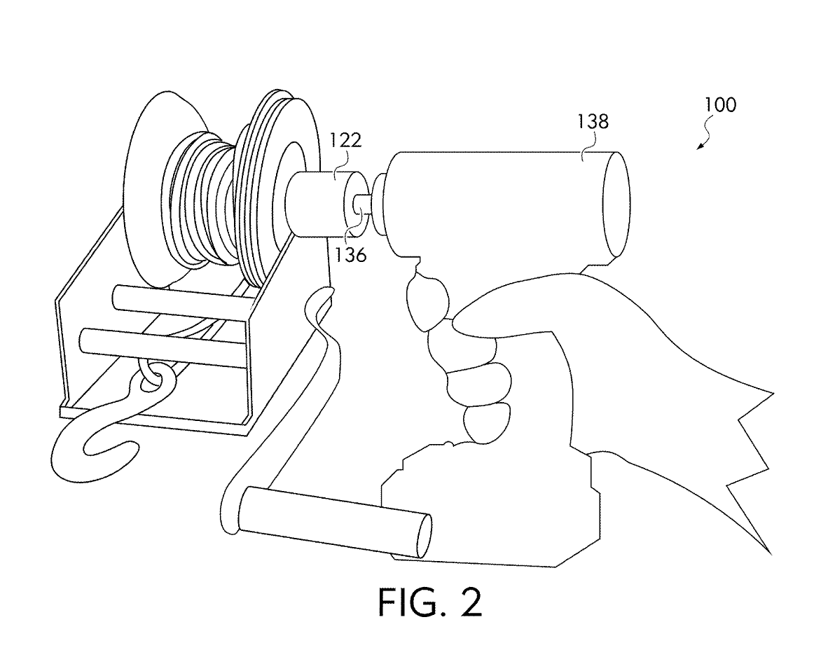

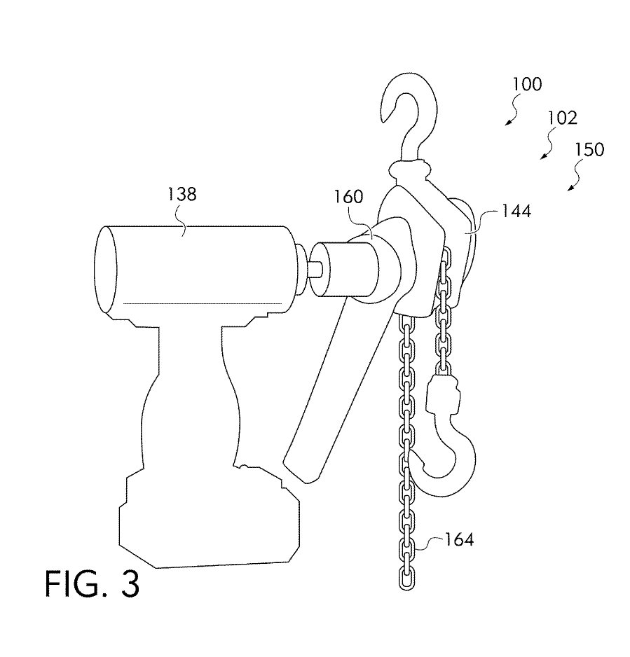

Referring now more specifically to the drawings by numerals of reference there is shown in FIGS. 1-4, various views of embodiments of the impact drive adaptor system 100 and impact drive adaptor for use with a screw jack system 200 in in-use condition(s) 150.

In an embodiment impact drive adaptor for use with a chain hoist system 102 is shown comprising: impact adaptor 120 including hardened steel cylindrical body 122 having outer wall surface 124, inner wall surface 126, hoist engaging end 130, and drive end 132 having tool receiver aperture 134; wherein the impact drive adaptor for use with a chain hoist system 102, comprises the impact adaptor 120, for use. Impact adaptor 120 preferably comprises hardened steel cylindrical body 122; wherein hardened steel cylindrical body 122, is defined by outer wall surface 124, inner wall surface 126, hoist engaging end 130, and drive end 132; drive end 132 providing tool receiver aperture 132, for receiving a lug of an impact gun 140. Impact adaptor 120 is engaged with the lug of impact gun 140 and impact gun 138, (when actuated impact adaptor 120, is caused to be turned such that free chain knob 160 coupled to chain hoist body 162, is able to be manipulated to move chain 164, in an upward motion and alternately a downward motion via hoist engaging end 130).

Referring to impact adaptor 120; impact adaptor 120 is configured to use as a joining member between impact gun 138, and mechanical hoist 144. Impact adaptor 120 is formed into hardened steel cylindrical body 122, for durability in use. Hoist engaging end 130 is opposed to drive end 132. Tool receiver aperture 134 is square-lug-receiver 136. Impact adaptor 120, engages about free chain knob 160 in certain embodiments. Inner wall surface 126 comprises a mating contour of an outer-face of the free chain knob 160. So that the impact adaptor engages into free chain knob 160. Free chain knob 160 comprises an axle engageable by hoist engaging end 130 of hardened steel cylindrical body 122. Axle is coupled to a ratcheting mechanism of a chain hoist. Drive end 132 is engageable with an extension.

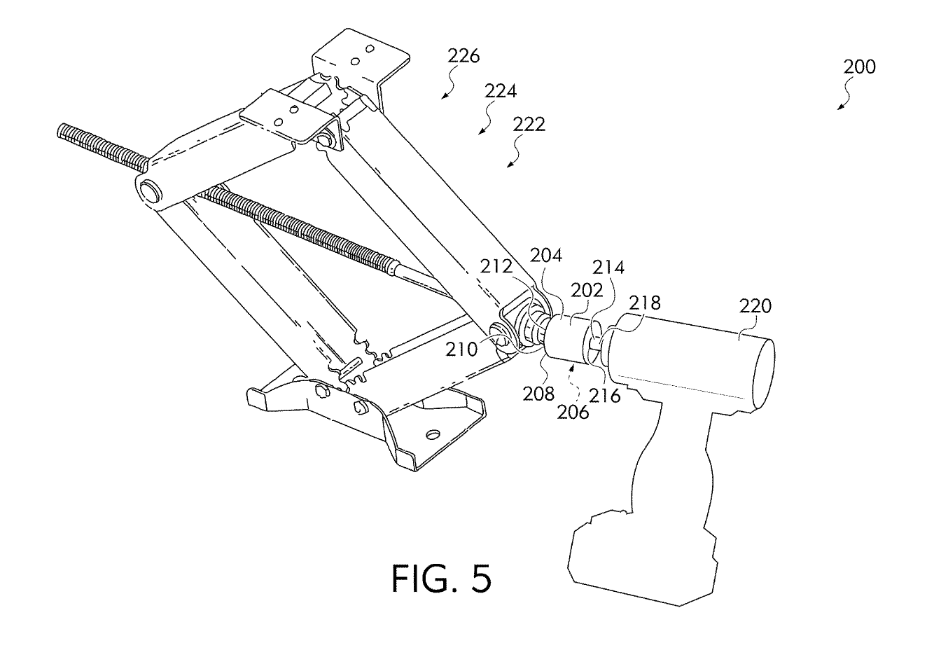

An impact drive adaptor for use with a screw jack system 200 is shown in FIG. 5 comprising: impact adaptor 210 (including hardened steel cylindrical body 202 having outer wall surface 204, inner wall surface 206, hoist engaging end 212, drive end 214 having tool receiver aperture 216); wherein impact drive adaptor for use with a screw jack system 200 comprises impact adaptor 210 for use.

Impact adaptor 210 comprises hardened steel cylindrical body 202, as mentioned; wherein hardened steel cylindrical body 202 is defined by outer wall surface 204, the inner wall surface 204, hoist engaging end 208, and the drive end 214, the drive end 214 providing tool receiver aperture 216 for receiving a lug of an impact gun 218, wherein when impact adaptor 210 is engaged with lug of impact gun 218 and impact gun 220 is actuated the impact adaptor 210 is caused to be turned such that the jack screw 222 is able to be manipulated to move a jack in an upward motion and alternately a downward motion via the hoist engaging end 208.

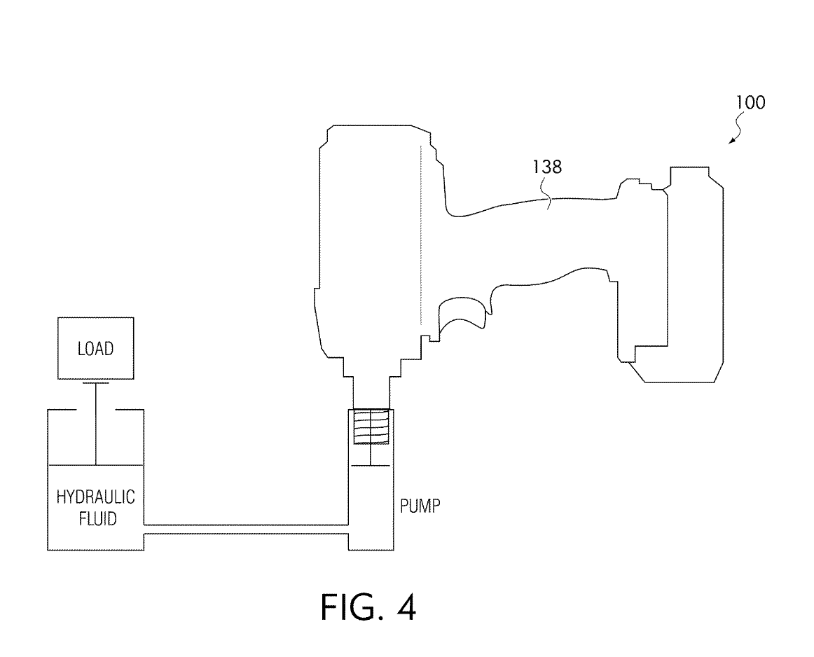

In this particular embodiment impact adapter 210 is configured to use as a joining member between impact gun 220 mechanical screw jack 224; screw jack 224 comprises a scissor version of screw jack 226. Screw jack 226 may comprise a non-scissor version of screw jack. Impact gun 220 may be pneumatically powered or electrically powered. Other versions are shown as coupled to pumps and the like in FIG. 4. Extensions and the like may also be used.

Impact drive adaptor system 100 may be sold as a kit comprising the following parts: at least one impact adaptor; and at least one set of user instructions. The kit has instructions such that functional relationships are detailed in relation to the structure of the invention (such that the invention can be used, maintained, or the like in a preferred manner).

Impact drive adaptor system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different coupling combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An impact drive adaptor for use with a chain hoist system comprising:
an impact adaptor including,
a hardened steel cylindrical body having,
an outer wall surface,
an inner wall surface,
a hoist engaging end, and
a drive end having,
a tool receiver aperture,
wherein said impact drive adaptor for use with a chain hoist system comprises said impact adaptor for use,
wherein said impact adaptor comprises said hardened steel cylindrical body,
wherein said hardened steel cylindrical body is defined by said outer wall surface, said inner wall surface, said hoist engaging end, and said drive end, said drive end providing said tool receiver aperture for receiving a lug of an impact gun, and
wherein when said impact adaptor is engaged with said lug of said impact gun and said impact gun is actuated said impact adaptor is caused to be turned such that a free chain knob is able to be manipulated to move a chain in an upward motion and alternately a downward motion via said hoist engaging end.

2. The impact drive adaptor for use with a chain hoist system of claim 1 wherein said impact adapter is configured to use as a joining member between a said impact gun and a mechanical hoist.

3. The impact drive adaptor for use with a chain hoist system of claim 2 wherein said impact adaptor is formed into said hardened steel cylindrical body for durability in use.

4. The impact drive adaptor for use with a chain hoist system of claim 3 wherein said hoist engaging end is opposed to said drive end.

5. The impact drive adaptor for use with a chain hoist system of claim 1 wherein said tool receiver aperture is a square-lug-receiver.

6. The impact drive adaptor for use with a chain hoist system of claim 1 wherein said impact adaptor engages about said free chain knob.

7. The impact drive adaptor for use with a chain hoist system of claim 6 wherein said inner wall surface comprises a mating contour of an outer-face of said free chain knob.

8. The impact drive adaptor for use with a chain hoist system of claim 1 wherein said impact adaptor engages into said free chain knob.

9. The impact drive adaptor for use with a chain hoist system of claim 8 wherein said free chain knob comprises an axle engageable by said hoist engaging end of said hardened steel cylindrical body.

10. The impact drive adaptor for use with a chain hoist system of claim 9 wherein said axle is coupled to a ratcheting mechanism of a chain hoist.

11. The impact drive adaptor for use with a chain hoist system of claim 1 wherein said drive end is engageable with an extension.

12. An impact drive adaptor for use with a screw jack system comprising:
an impact adaptor including,
a hardened steel cylindrical body having,
an outer wall surface,
an inner wall surface,
a hoist engaging end, and
a drive end having,
a tool receiver aperture,
wherein said impact drive adaptor for use with a screw jack system comprises said impact adaptor for use,
wherein said impact adaptor comprises said hardened steel cylindrical body,
wherein said hardened steel cylindrical body is defined by said outer wall surface, said inner wall surface, said hoist engaging end, and said drive end, said drive end providing said tool receiver aperture for receiving a lug of an impact gun, and
wherein when said impact adaptor is engaged with said lug of said impact gun and said impact gun is actuated said impact adaptor is caused to be turned such that said jack screw is able to be manipulated to move a jack in an upward motion and alternately a downward motion via said hoist engaging end.

13. The impact drive adaptor for use with a screw jack system of claim 12 wherein said adapter is configured to use as a joining member between said impact gun and a mechanical said screw jack.

14. The impact drive adaptor for use with a screw jack system of claim 12 wherein said jack comprises a scissor said screw jack.

15. The impact drive adaptor for use with a screw jack system of claim 12 wherein said jack comprises a non-scissor said screw jack.

16. The impact drive adaptor for use with a screw jack system of claim 1 wherein said impact gun is pneumatically powered.

17. The impact drive adaptor for use with a screw jack system of claim 1 wherein said impact gun is electrically powered.

18. A method of using an impact drive adaptor comprising the steps of:
engaging a mechanical lifting device with an impact adaptor; and
activating said impact adaptor via an impact gun causing said mechanical lifting device to raise and alternately lower.

19. The method of claim 18 wherein said mechanical lifting device comprises a mechanical chain hoist.

20. The method of claim 18 wherein said mechanical lifting device comprises a pump.
